(19) United States
(12) Patent Application Publication
(10) Pub. No.: US 2008/0114755 A1
(43) Pub. Date: May 15, 2008

(54) IDENTIFYING SOURCES OF MEDIA CONTENT HAVING A HIGH LIKELIHOOD OF PRODUCING ON-TOPIC CONTENT

(75) Inventors: Timothy J. Wolters, Superior, CO (US); Mehrshad Setayesh, Lafayette, CO (US)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: COLLECTIVE INTELLECT, INC., Boulder, CO (US)

(21) Appl. No.: 11/938,691

(22) Filed: Nov. 12, 2007

Related U.S. Application Data
(60) Provisional application No. 60/969,950, filed on Sep. 5, 2007.
(60) Provisional application No. 60/866,064, filed on Nov. 15, 2006.

(51) Int. Cl. G06F 17/30

(52) U.S. Cl. 707/5; 707/E17.109

(57) ABSTRACT

Methods and systems are provided for identifying on-topic sources of media content. According to one embodiment, candidate seed sites are identified from which current seeds are selected for deep crawling. The current seeds are identified by correlating relevancy scores or key-word search results from multiple search engines; and selecting the current seeds based on on-topic scores of the candidate seeds. Periodically, a topic net associated with the topic area of interest is executed to locate relevant sources of media content by (i) building a graph in which nodes represent pages and edges represent links among pages by performing an iterative 360 crawl starting from the seeds; (ii) assigning initial node graph scores; (iii) computing final node graph scores by performing link analysis; (iv) computing a site graph scores by aggregating and averaging corresponding node graph scores; and (v) configuring sites with the highest site graph scores to be scraped.

### CROSS-REFERENCE TO RELATED APPLICATIONS

This application claims the benefit of priority to U.S. Provisional Patent Application No. 60/969,950 filed on Sep. 5, 2007 and U.S. Provisional Patent Application No. 60/866,064 filed on Nov. 15, 2006, both of which are hereby incorporated by reference in their entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2006-2007, Collective Intellect, Inc.

### BACKGROUND

1. Field

Embodiments of the present invention generally relate to filters, ranking mechanisms and/or readers of news, messages, Really Simple Syndication, Rich Site Summary or RDF Site Summary (collectively, RSS) feeds, message board postings, pod casts, instant messaging chat transcripts, chat room transcripts and other unstructured data and Consumer Generated Media (CGM), such as that presented on discussion boards, social networking websites, news websites, weblogs (blogs), podcasts and other forms of text message, audio and/or video available via the Internet. More specifically, embodiments of the present invention relate to mechanisms for finding valid and important sources of information on the Web around a specific topic of interest.

2. Description of the Related Art

Search engines, such as Google, are adequate for generalized ad hoc searches, but are not very good at keeping the information consumer up to date regarding the best content on a subject from the user's perspective. Consequently, there is a need for automated techniques of proactively identifying and gathering new posts from blogs or traditional media sources that are personalized to a user's specific interests.

### SUMMARY

Methods and systems are described for proactively and programmatically identifying sources of media content having a high likelihood of producing on-topic content in relation to a specific topic of interest. According to one embodiment, responsive to receiving a definition of a topic area of interest of multiple topic areas of interest, a set of candidate seed sites are identified from which a current set of seeds are selected for deep crawling to locate on-topic content relevant to the topic area of interest. The current set of seeds are identified by correlating relevancy scores or key-word search results from multiple search engines; and selecting the current set of seeds from the candidate seed sites based at least in part on on-topic scores associated with the candidate seed sites. On a periodic basis a topic net corresponding to the topic area of interest is executed to locate sources of media content relevant to the topic area of interest. The sources of media content are located by (i) building a graph in which nodes of the graph represent pages and edges of the graph represent links among pages by performing an iterative crawl until a predetermined degree of separation is achieved to find a list of pages linking to any seed of the current set of seeds and a list of pages to which any seed of the current set of seeds links; (ii) assigning initial graph scores to each node of the graph; (iii) computing final graph scores for each node based on the initial graph scores by performing link analysis on the graph; (iv) computing a site graph score for each site represented in the graph by its set of pages by aggregating and averaging the node graph scores associated with the site; and (v) identifying a set of sites with the highest site graph scores and configuring them to be scraped. Finally, pages associated with the sites configured to be scraped are scraped and downloaded.

According to one aspect of an embodiment of the present invention, the set of sites and the current set of seeds may be weblogs (blogs) and the pages may be blog posts.

According to one aspect of an embodiment of the present invention, the health of the topic areas of interest may be measured by performing health analysis.

According to another aspect of an embodiment of the present invention, the health analysis may involve (i) producing metrics relating to various health parameters for each site of the set of sites and each seed of the current set of seeds, including a number of new posts created and an average post relevancy score, by evaluating posts associated with the set of sites and the current set of seeds; and (ii) adding or subtracting seeds from the current set of seeds for use in a next topic net execution iteration based on the metrics.

According to one aspect of an embodiment of the present invention, a quality centrality measure may be created for each of the topic areas of interest.

According to another aspect of an embodiment of the present invention, quality centrality measure may be based upon latent semantic analysis.

According to one aspect of an embodiment of the present invention, the initial graph scores may be based upon one or more of a topic density score, a maven density score and a relevancy score.

According to one aspect of an embodiment of the present invention, prior to selecting the current set of seeds from the candidate seed sites, filtering may be performed to remove spam blogs from the candidate seed sites.

According to another aspect of an embodiment of the present invention, the filtering may involve the use of a spam blog (splog) detector comprising a text classification engine that discriminates between uniform resource locators (URLs) of legitimate blog home pages and splog home pages.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a high-level conceptual illustration of a post gathering and filtering process according to one embodiment of the present invention.

FIG. 2 is a block diagram conceptually illustrating a simplified network architecture in which embodiments of the present invention may be employed.

FIG. 3 is a block diagram conceptually illustrating interactions among the various subsystems and functional units of a service domain in accordance with one embodiment of the present invention.

FIG. 4 is an example of a computer system with which embodiments of the present invention may be utilized.

FIG. 5 is a simplified flow diagram illustrating at a high-level overall topic net processing in accordance with an embodiment of the present invention.

FIG. 6 is a flow diagram illustrating initial topic net seed discovery in accordance with an embodiment of the present invention.

FIG. 7 is a flow diagram illustrating content quality training processing according to one embodiment of the present invention.

FIGS. 8A and 8B together represent a flow diagram illustrating topic net execution processing according to one embodiment of the present invention.

FIG. 9 is a flow diagram illustrating health analysis processing according to one embodiment of the present invention.

FIG. 10 conceptually illustrates potential hubs or seeds in the context of a sample mapping of a sites under consideration to be part of a topic net according to one embodiment of the present invention.

FIG. 11 illustrates a user interface widget through which end users of subscribers can access on-topic content in accordance with an embodiment of the present invention.

### DETAILED DESCRIPTION

Methods and systems are described for proactively and programmatically identifying sources of media content having a high likelihood of producing on-topic content in relation to a specific topic of interest. According to one embodiment, in the context of blog sites, the approach uses an initial set of seed blog sites to build a graph as a result of deep crawling of the web. The graph is then analyzed from both a link perspective and a content perspective to identify target blog sites with a high likelihood of producing the desired on-topic content. In one embodiment, the nodes of the graph represent posts and the edges represent inbound/outbound citations among posts. As part of the analysis of the graph, various scores with different weights may be assigned to each node based on measures of on-topic posts generated by the associated blog sites. According to one embodiment, subsequent execution of a topic net involves monitoring the health of the topic net to determine whether additional seeding is needed.

In one embodiment, the initial set of seed sites for a topic net are used in an iterative 360 crawling mode to find a list of posts linking to the seed (backward crawling) and also a list of posts to which the seed links (forward crawling). Ideal seeds typically have (i) a large following on the web; and (ii) high quality posts within the scope of the topic of interest (e.g., the topic net). In one embodiment, a site having a lesser following, such as a new blog, with high quality posts and on-topic content may be selected as a seed. In any event, subsequent iterations of the 360 crawling mode may consider the posts discovered in the previous iteration and perform further forward and backward crawling for each one until a configurable stopping condition has been achieved.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, various embodiments of the present invention may be described with reference to text messages in the context of RSS feeds, message boards and blogs, the present invention is equally applicable to various other forms of CGM found on the Internet, such as audio and video content. For example, embodiments of the present invention may perform ranking of videos and/or video authors based on metadata, e.g., text descriptions and/or other tagging, associated with videos residing on video sharing websites. As such, use of terms and phrases, such as blog, blog site, web site, post, web page and the like may be used for sake of brevity, without limiting or detracting from the meaning denoted or implied by the broader terms and phrases, such as information resource, sources of media content, content and the like.

### Terminology

Brief definitions of terms, abbreviations, and phrases used throughout this application are given below.

The phrase “blog growth rate” generally refers to a measure of the rate of increase/decrease of blogs associated with a topic net. The number of blogs associated with a topic net may change based on, among other things, the creation of new blogs, the reassignment of a blog previously associated with the current topic net to a different topic net, the reassignment of a blog previously associated with a different topic net to the current topic net and the discontinuance of a blog. Blog growth may be measured in terms of percentage growth or net increase in blogs associated with a topic net from one iteration to the next.

The terms “connected” or “coupled” and related terms are used in an operational sense and are not necessarily limited to a direct physical connection or coupling. Thus, for example, two devices may be couple directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrase “consumer generated media” or the acronym “CGM” generally refer to consumer-created content, including but not limited to postings, messages, blogs, podcasts, videos, audio and the like. Typically, consumer-generated media encompasses opinions, experiences, advice and commentary about products, brands, companies and services—usually informed by personal experience—that exist in consumer-created postings on Internet discussion boards, forums, social networking sites, message boards, web communities, video sharing websites, Usenet newsgroups and blogs. CGM can include text, images, photos, videos, podcasts and other forms of media.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The term “maven” generally refers to an author that originates ideas and/or influences others to adopt ideas. Mavens may be identified by multiple means, one of which is to perform a link analysis across authors who publish information by subject. This will find the authors that other authors on the subject tend to listen to. Such mavens are referred to herein as “subject mavens.”

The phrase “maven density” generally refers to a score that is used to compare authors within a topic net. In one embodiment, maven density is a score between 0 and 10 and is assigned to each author in each topic net. Maven density may consider the score of all author's posts within a topic net. Generally, the more posts with high scores an author has in a topic net, the higher the author's maven density will be.

The phrase “maximum blog count” generally refers to a maximum acceptable number of active blogs associated with a topic net. In one embodiment, the maximum blog count represents one of several health parameters that may be monitored in connection with periodic health analysis of topic nets.

The phrase “maximum seed count” generally refers to a maximum acceptable number of sites tagged as seeds for a topic net. In one embodiment, the maximum seed count represents one of several health parameters that may be monitored in connection with periodic health analysis of topic nets. According to one embodiment, a topic net may be a candidate for division into multiple topic nets if the number of seeds associated with the topic net exceeds the maximum seed count. Alternatively, the number of seeds may be reduced by imposing a higher seed graph score threshold, for example.

If the specification states a component or feature “may”, “can”, “could”, or “might” be included or have a characteristic, that particular component or feature is not required to be included or have the characteristic.

The phrase “minimum blog count” generally refers to a minimum acceptable number of active blogs associated with a topic net. In one embodiment, the minimum blog count represents one of several health parameters that may be monitored in connection with periodic health analysis of topic nets.

The phrase “minimum graph score to scrape” generally refers to a minimum acceptable graph score to tag a site associated with a topic net for scraping. In one embodiment, the nodes of a graph of relevant posts identified during a 360 crawling mode are scored and assigned weights that are used in a link analysis process. A graph score may be obtained based on the graph as described further below. Then, sites with graph scores greater than the minimum graph score to scrape are scrape candidates.

The phrase “minimum graph score to seed” generally refers to a minimum acceptable graph score to tag a site as a seed for a topic net. In one embodiment, the graph score obtained based on the graph resulting from the 360 crawling mode is compared to the minimum graph score to seed and those sites having graph scores greater than the minimum graph score to seed are seed candidates within the topic net.

The phrase “minimum on-topic percentage to scrape” generally refers to a minimum acceptable percentage of on-topic posts for a site associated with a topic net to be tagged for scraping.

The phrase “minimum on-topic percentage to seed” generally refers to a minimum acceptable percentage of on-topic posts for a site to be tagged as a seed for a topic net.

The phrase “minimum post count” generally refers to a minimum acceptable number of new posts created for a topic net during a predefined period. In one embodiment, the minimum post count represents one of several health parameters that may be monitored in connection with periodic health analysis of topic nets.

The phrase “minimum post score” generally refers a minimum acceptable content score for a post of a topic net. In one embodiment, the minimum post score represents one of several health parameters used in connection with periodic health analysis of topic nets. According to one embodiment, the content score represents the relevance of a post's data as compared to the domain expertise defined by the post pool built during a training phase.

The phrase “minimum seed count” generally refers to a minimum acceptable number of sites tagged as seeds for a topic net. In one embodiment, the minimum seed count represents one of several health parameters that may be monitored in connection with periodic health analysis of topic nets. According to one embodiment, additional seeding may be performed for a topic net if the number of seeds associated with the topic net falls below its minimum seed count.

The phrase “on-topic score” or “on-topic percentage” generally refers to a site score measuring the ratio of on-topic posts to total posts for a particular site. In one embodiment, posts are retrieved from each scraped site and each post is evaluated to determine whether it is on-topic within the current topic net. Then, the on-topic score can be computed by dividing the number of on-topic posts by the total number of posts analyzed.

The phrase “post growth rate” generally refers to a measure of the rate of new post creation within a topic net. Post growth may be measured in terms of percentage growth or net increase in posts from topic net iteration to topic net iteration.

The term “responsive” includes completely or partially responsive.

The term “topic” generally refers to a subject into which a post, a message or other form of unstructured consumer generated media was categorized. Posts may be categorized using any number of off-the-shelf statistical or natural language processing products.

The phrase “topic density” generally refers to a score that is used to measure an author's relative contribution to a topic net. In this context, author is used broadly to refer to a particular information resource, such as a blog with one or more contributors, as well as to a particular individual. In one embodiment, topic density is a score between 0 and 10 and the more an author has posts associated with a topic net as a percentage of all posts within the topic net, the higher that author's topic density will be. In one embodiment, topic density is a function of a ratio of the number of posts the author contributed to the total number of posts on topic for the period, and the number of the author's posts on topic vs. the number of the author's posts off topic.

The phrase “topic net” generally refers to a way of finding valid and important sources of information on the Web around a specific topic of interest.

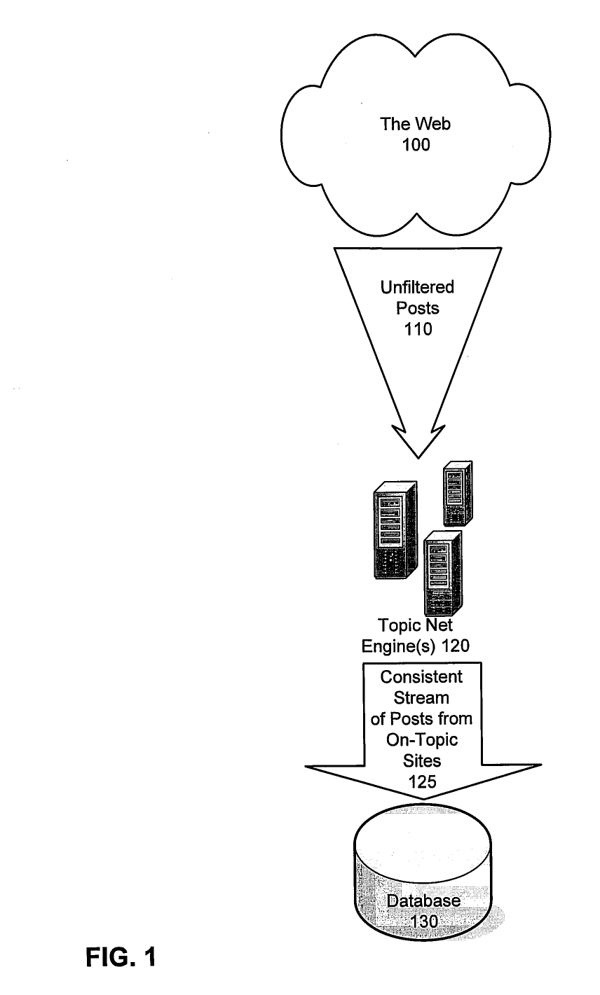

FIG. 1 is a high-level conceptual illustration of a post gathering and filtering process according to one embodiment of the present invention. From this high-level perspective, topic net engine(s) 120 receive unfiltered posts 110 and output a consistent stream 125 of posts from on-topic sites to a database 130. The unfiltered posts 110 may include millions of posts gathered from the Web 100. The unfiltered posts 110 typically include spam posts as well as both on-topic and off-topic posts with various levels of quality. Post gathering and filtering performed by the topic net engine(s) 120 are described further below.

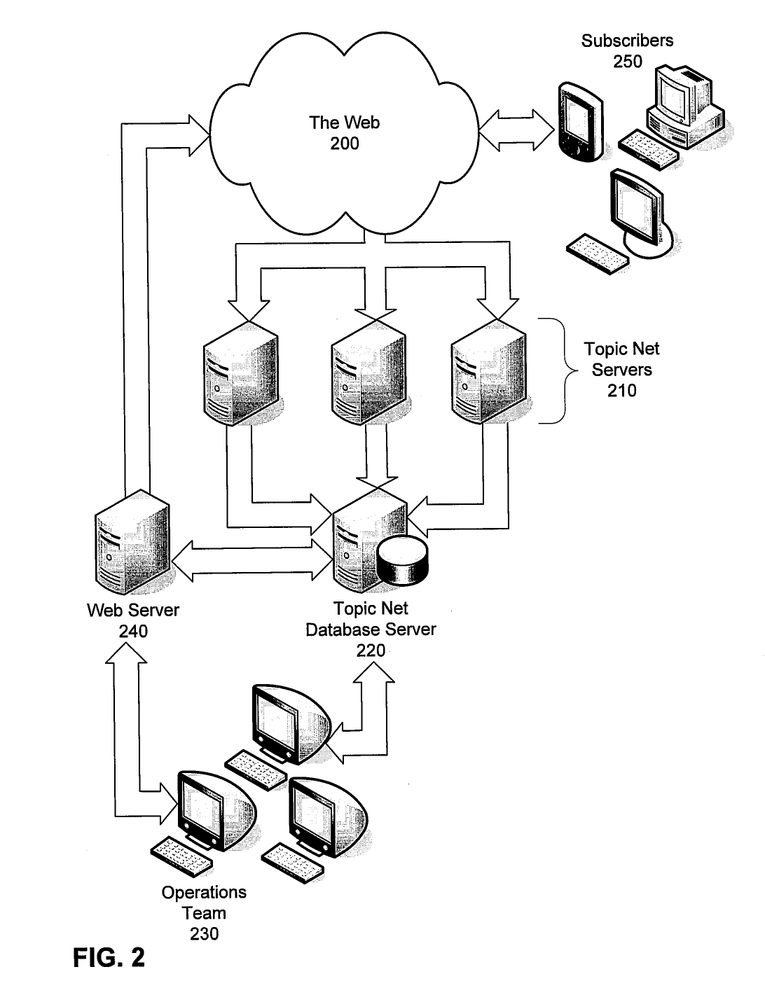

FIG. 2 is a block diagram conceptually illustrating a simplified network architecture in which embodiments of the present invention may be employed. In the context of the present example, one or more topic net servers 210 of a new media delivery service gather posts from the web 200 by identifying initial seeds and building a web graph. As described in further detail below, subsequent execution of a topic net may involve monitoring the health of the topic net to, among other things, determine if additional seeding is needed to adjust the health of the topic net and/or detect shifts in expertise.

In the network architecture of the present example, a topic net database server 220 may receive topic net configuration data created by an operations team 230. In one embodiment, a topic net configuration consists of its name, topics, seeds, growth parameters, automation parameters, etc. The topic net servers 210 may use the topic net configurations stored by the topic net database server 220 to execute the topic nets as described further below. The results of the topic net execution, such as the graphs (e.g., nodes and links), list of scored sites, reports, etc. may also be stored on the topic net database server 220

The operations team 230 of a new media delivery service provider may be provided with various tools to create and manage topic nets, scored sites, reports, etc. In one embodiment, the operations team 230 creates and/or modifies configuration data for the various topic nets. The operations team 230 may also proactively review and evaluate various weblogs for inclusion within the topic net execution processing. For example, members of the operations team 230 may tag sites for scraping and/or as seeds and otherwise identify and appropriately categorize sites relevant to various topics of interest to subscribers between topic net execution iterations. In one embodiment, the operations team 230 may also have the ability to increase and/or decrease automatically assigned quality scores.

In one embodiment, the web server 240 serves HyperText Markup Language (HTML) pages allowing the operations team 230 to create and manage topic nets, scored sites, reports, etc. The web server 240 may also display lists of running topic nets and their respective states.

In the context of the present example, subscribers 250 access on-topic posts by accessing information from sites the web server 240 has published to the web 200. In one embodiment, subscribers 250 may interact with the new media delivery service via a user interface widget. As described in further detail below, the user interface widget may proactively advise subscribers 250 regarding the availability of on-topic content of interest. In one embodiment, subscribers 250 may provide feedback regarding content identified by the topic net execution process. Such feedback may be used to increase and/or decrease assigned quality scores.

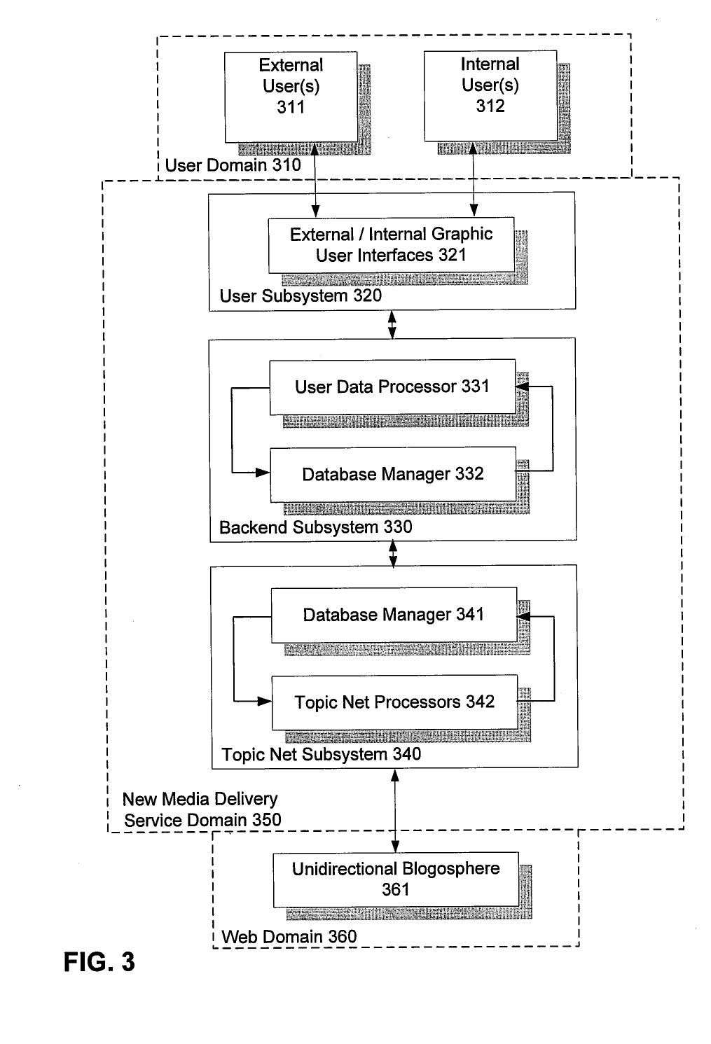

FIG. 3 is a block diagram conceptually illustrating interactions among the various subsystems and functional units of a service domain in accordance with one embodiment of the present invention. In the present example, three domains are illustrated, a user domain 310, a new media delivery service domain 350 and a web domain 360.

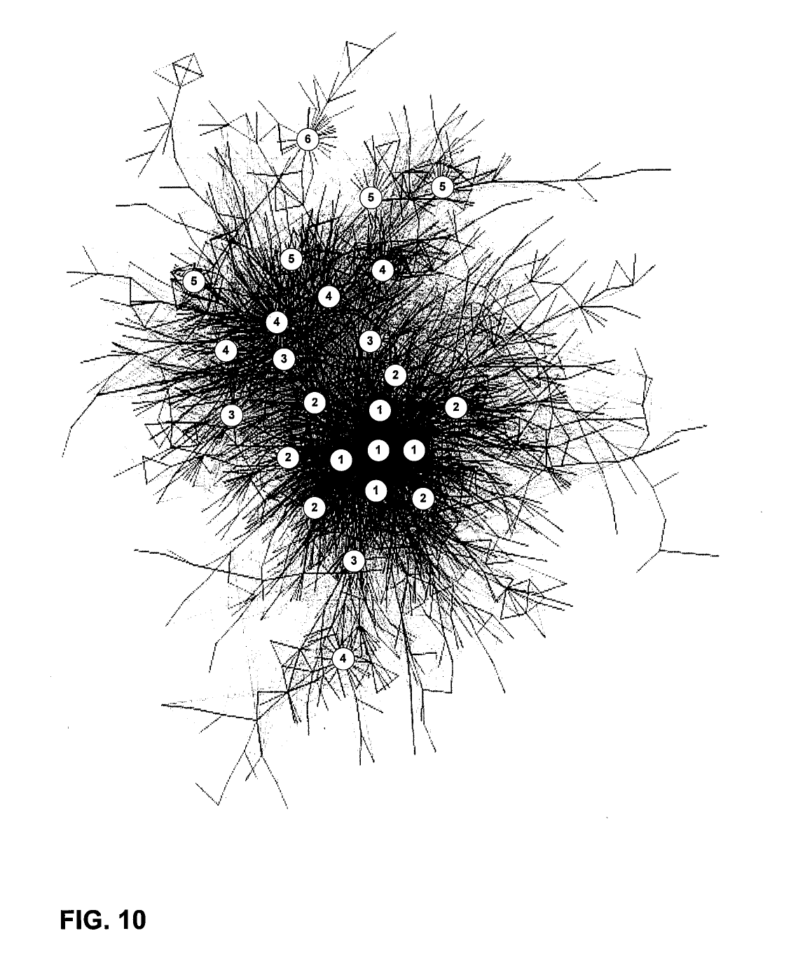

The web domain 360 includes the unidirectional blogosphere (e.g., the universe of weblogs on the web). The blogosphere is referred to as unidirectional because the hypertext links that connect blogs are unidirectional in nature. That is, a user can navigate forward by selecting a link, but a user cannot navigate backward as the user is not aware of what pages link to the current site. For example, when one goes to cnn.com, he/she can navigate forward by following links to sites to which CNN links, but he/she cannot navigate backward because he/she does not know what pages link to CNN. A conceptual illustration of a subset of the blogosphere is depicted in FIG. 10.

The new media delivery service domain 350 includes a topic net subsystem 340, a backend subsystem 330 and a user subsystem 320. According to this example, the topic net subsystem 340 includes a database manager 341 and one or more topic net processors 342. The backend subsystem 330 includes a database manager 332 and a user data processor 331. The user subsystem 320 includes external/internal graphic user interfaces 321.

The user domain 310 includes external users 311 and internal users 312. External users 311 may include subscribers, such as subscribers 250. Internal users 312 may include staff of the new media delivery service, such as operations team 230.

According to one embodiment, configuration information and topic net summary data are stored in a database (not shown) associated with the topic net subsystem 340. According to the present example, the database is split into multiple instances (e.g., database manager 341 and database manager 332) to enhance performance.

In accordance with the present example, the topic net subsystem 340 may interact with the web domain 360 to create a graph consisting of sites and citations between them by performing a 360 crawl starting from seeds as described further below. In one embodiment, the graph resulting from the 360 crawl may be stored in database manager 341. The topic net processors 342 read topic net configurations from the database manager 341 and interact with the web domain 360 to build and store the graphs in the database manager 341. In addition, according to various embodiments, the topic net processors 342 compute other factors, such as maven densities, topic densities, final site scores, etc.

According to the architecture of the present example, the database manager 341 slaves the database manager 332 of backend subsystem 330 and copies over all topic net configuration used by topic net processors 342. In addition, extra scores, such as maven densities, topic densities and final site scores may be sent back to the database manager 332 to be served by the user subsystem 320.

The backend subsystem 330 includes database manager 332 and a user data processor 331. In one embodiment, the database manager 332 stores all topic net configurations in addition to results associated with execution of topic nets by the topic net processors 342. The database manager 332 may slave database manager 341 so all results of the execution of topic net processors 342 are transferred to database manager 332. Meanwhile, database manager 332 is also master to database manager 341 so required information, such as topic net configuration data are transferred to database manager 341. In one embodiment, the breakdown of these two databases is for performance reasons to allow the topic net processors 342 and the user data processor 331 to both interact with their own database without slowing performance of each other. Meanwhile, data can be transferred in low priority order between the two databases.

In one embodiment, the functionality of one or more of the above-referenced functional units may be merged in various combinations. For example, the database manager 332 and the database manager 341 may be merged into a single database or incorporated within either of the topic net processors 342 or the user data processor 331. Moreover, the functional units can be communicatively coupled using any suitable communication method (e.g., message passing, parameter passing, and/or signals through one or more communication paths etc.). Additionally, the functional units can be physically connected according to any suitable interconnection architecture (e.g., fully connected, hypercube, etc.).

According to embodiments of the invention, the functional units can be any suitable type of logic (e.g., digital logic) for executing the operations described herein. Any of the functional units used in conjunction with embodiments of the invention can include machine-readable media including instructions for performing operations described herein. Machine-readable media include any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.), etc.

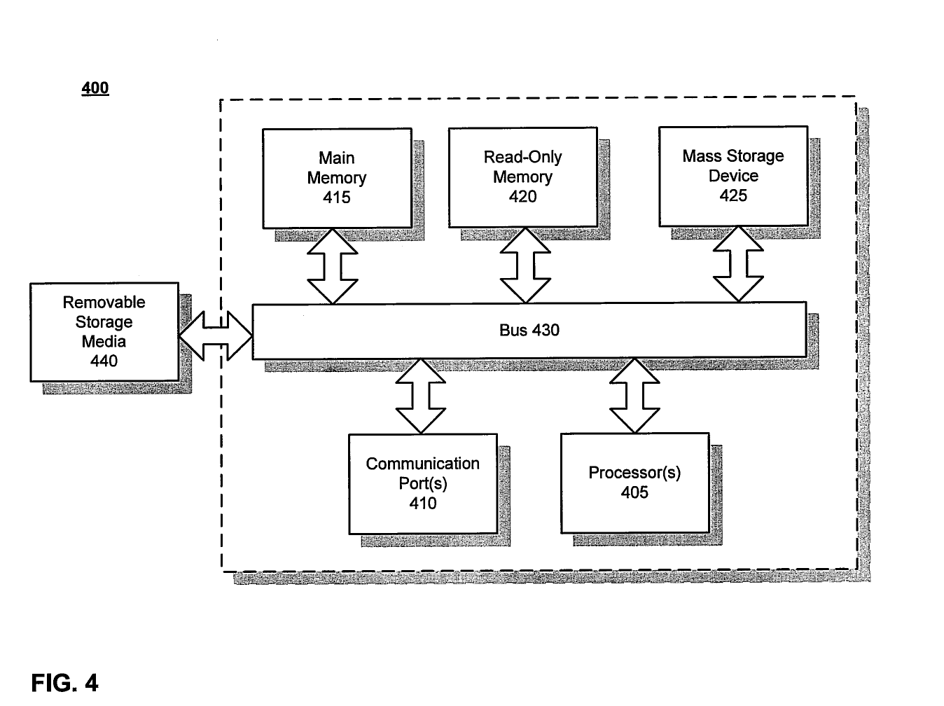

FIG. 4 is an example of a computer system with which embodiments of the present invention may be utilized. The computer system 300 may represent or form a part of a web server, database server, application server, client workstation and/or other device implementing one or more of the functions performed by the topic net servers 210, the topic net database server 220, the web server 240 and/or the operations team 230. According to FIG. 4, the computer system 400 includes one or more processors 405, one or more communication ports 410, main memory 415, read only memory 420, mass storage 425, a bus 430, and removable storage media 440.

The processor(s) 405 may be Intel® Itanium® or Itanium 2® processor(s), AMD® Opteron® or Athlon MP® processor(s) or other processors known in the art.

Communication port(s) 410 represent physical and/or logical ports. For example communication port(s) may be any of an RS-232 port for use with a modem based dialup connection, a 10/100 Ethernet port, or a Gigabit port using copper or fiber. Communication port(s) 410 may be chosen depending on a network such a Local Area Network (LAN), Wide Area Network (WAN), or any network to which the computer system 400 connects.

Communication port(s) 410 may also be the name of the end of a logical connection (e.g., a Transmission Control Protocol (TCP) port or a Universal Datagram Protocol (UDP) port). For example communication ports may be one of the Well Know Ports, such as TCP port 80 (used for HTTP service), assigned by the Internet Assigned Numbers Authority (IANA) for specific uses.

Main memory 415 may be Random Access Memory (RAM), or any other dynamic storage device(s) commonly known in the art.

Read only memory 420 may be any static storage device(s) such as Programmable Read Only Memory (PROM) chips for storing static information such as instructions for processors 405.

Mass storage 425 may be used to store information and instructions. For example, hard disks such as the Adaptec® family of SCSI drives, an optical disc, an array of disks such as RAID, such as the Adaptec family of RAID drives, or any other mass storage devices may be used.

Bus 430 communicatively couples processor(s) 405 with the other memory, storage and communication blocks. Bus 430 may be a PCI/PCI-X or SCSI based system bus depending on the storage devices used.

Optional removable storage media 440 may be any kind of external hard-drives, floppy drives, IOMEGA® Zip Drives, Compact Disc-Read Only Memory (CD-ROM), Compact Disc—Re-Writable (CD-RW), Digital Video Disk (DVD)—Read Only Memory (DVD-ROM), Re-Writable DVD and the like.

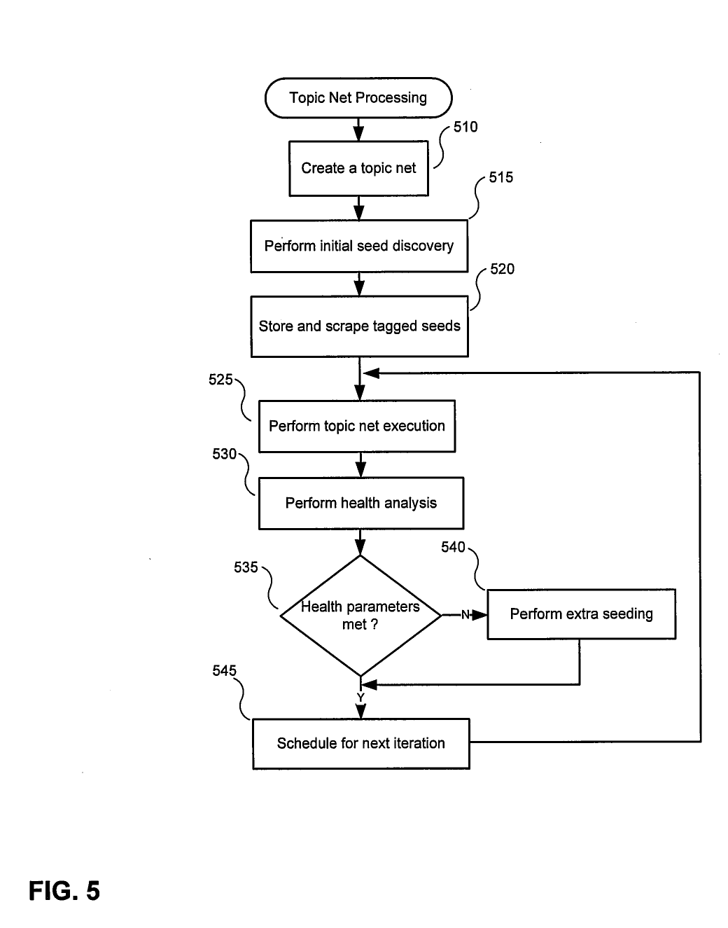

FIG. 5 is a simplified flow diagram illustrating at a high-level overall topic net processing in accordance with an embodiment of the present invention.

At block 510, a topic net is created. According to one embodiment, topic net creation includes assigning a name to the topic net and defining various topic net parameters. Topic net parameters may include expertise, growth, health and automation parameters. As described below, topic net creation may be performed programmatically, manually or by a combination of programmatic and manual steps. For example, an operations team, such as operations team 230, may create a topic net on the Global Positioning System (GPS) and Navigation and configure it with various parameters for expertise, growth, health and automation. Alternatively or additionally, the subscriber base may participate in the topic net creation process.

In one embodiment, defining the expertise parameters involves defining a list of tags using Boolean expressions, which together define the scope of the topic net. During topic net execution, the expertise parameters may be used to determine whether a post is relevant to the topic net's expertise. In the context of a topic net relating to Apple's iPod, Boolean and keyword searching such as the following may be used in accordance with an embodiment of the present invention to identify relevant posts: “IPOD=(apple OR ipod) and mp3 or (music DNEAR download) and itunes”. As described further below, in one embodiment, when the Boolean expression is not matched, the post is ignored. If the post is matched, a relevancy ranking is assigned and the post is recursed into the next iteration of crawling.

According to one embodiment, growth parameters include post and site growth rates, which determine the growth of the topic net on a periodic basis.

Health parameters allow for monitoring and measurement of the topic net's health. Sample health parameters include minimum post count, maximum post count and average post score. As described further below, one or more health parameters may help identify a topic net that is in declining health and that may need to be infused with new or additional seeds. For example, a topic net that does not produce a sufficient number of new posts within a predefined period or maintain a certain active blog count may be manually or programmatically determined to need additional seeding to improve the health of the topic net. A topic net that exceeds a certain number of posts may be a candidate for splitting into multiple topic nets. A topic net that does not meet a minimum threshold in terms of its average post score may be deemed unhealthy as a result of inclusion of low quality posts.

For a relatively small topic net, such as GPS and Navigation, a minimum of 50 to 100 posts may be expected to be created each week, an average post/relevancy/on-topic score of 2 to 4 (on a scale of 0 to 10) may be required for scraping, an average post/relevancy/on-topic score of 5 to 10 (on a scale of 0 to 10) may be required to achieve seed status and at least 10 to 20 active blogs might be desired. For a larger topic net, such as Autos, a minimum of 100 to 500 posts may be expected to be created each week, an average post/relevancy/on-topic score of 2 to 4 (on a scale of 0 to 10) may be required for scraping, an average post/relevancy/on-topic score of 5 to 10 (on a scale of 0 to 10) may be required to achieve seed status and at least 20 to 100 active blogs might be desired. In one embodiment, health parameters may be adjusted as appropriate based on the size of the topic net. For example, staff of the new media delivery service, such as operations team 230, may adjust health parameters to encourage the desired effect (e.g., size preservation, growth, etc.) on the topic net.

In one embodiment, automation parameters may be defined to facilitate automated execution of the topic net. For example, minimum graph score and/or minimum on-topic percent parameters may help identify topic nets in needs manual intervention or that may continue to be programmatically executed.

At block 515, initial seed discovery is performed. In one embodiment, the goal of the initial seeding process is to discover sites that have both a large following on the web and high quality posts that fall within the scope of the topic net. According to the present example, after a topic net has been created, tags from the creation phase are used to run automated searches for content on the web. As explained below, in one embodiment, proprietary algorithms, existing publicly available search engines and/or site relevancy information, such as Yahoo!, Google, IceRocket and the like, may be used. In any event, to the extent multiple search engine results and/or relevancy information are acquired, such results may be intersected to identify a consensus set of results, from which a set of initial seed sites may be selected.

At block 520, after the initial seed sites for a topic net have been identified, content from the tagged seeds is scraped. According to one embodiment, RSS content or other web feed formatted data is read from the tagged seed sites using a feed reader. Content may also be downloaded or otherwise mined by automatically searching through the tagged seed sites. As described further below, in one embodiment, the content downloaded from the tagged seeds may be used to define a high quality expertise pool for the topic net. Content quality training may be performed on the high quality expertise pool to define a quality centrality measure that may be used to assign relevancy scores to newly considered sites.

At block 525, the topic net is executed. In one embodiment, topic net execution involves, among other things, building a graph of relevant posts identified during a 360 crawling mode starting at the set of initial seeds identified in block 515. The nodes of the graph are then scored and assigned weights that are used in a link analysis process to identify hub sites that can be regularly monitored and from which content can be scraped. In one embodiment, the link analysis process may include the hubs and authorities identification algorithm as described in U.S. Pat. No. 6,112,202, which is hereby incorporated by reference in its entirety for all purposes.

Additionally, during topic net execution, various reports, statistics and metrics may be generated to facilitate evaluation and/or enhancement of the topic net. For example, graph scores and on-topic percentages may be logged for sites that are not currently tagged as seeds to allow their subsequent evaluation as seed candidates should extra seeding be determined to be needed to improve the health of the topic net. Further details regarding topic net execution in accordance with an embodiment of the present invention are provided below.

At block 530, health analysis processing is performed. In one embodiment, following each iteration, all sites associated with a topic net, including both seed sites and those sites that are merely tagged for scraping, and their posts are evaluated to produce metrics relating to the various health parameters defined during creation of the topic net (see, e.g., block 510). In one embodiment, topic net seeds are analyzed to validate their continuing seed status. Various health analysis processing techniques that may be employed by embodiments of the present invention are described further below.

At decision block 535, the metrics generated during the health analysis processing are evaluated against the health parameters to determine whether the health parameters are sufficiently satisfied. If the health parameters have been met by the topic net, then processing continues with block 545; otherwise, processing branches to block 540.

At block 540, extra seeding is performed. In one embodiment, the automation parameters defined during topic net creation are used to determine additional seed sites. For example, sites currently being scraped that have achieved a sufficiently high graph score and/or sufficiently high on-topic percentage may be promoted to seeds for subsequent topic net execution iterations. Meanwhile, other sites observed during deep crawling that are not currently being scraped, but which have now achieved a sufficiently high graph score and/or a sufficiently high on-topic percentage may be tagged as sites to begin scraping in the next topic net execution iteration.

At block 545, since it was either determined with reference to the various health parameters, at decision block 535 that the topic net was healthy or auto seeding has been performed at block 540 to enhance the health of the topic net, the topic net is now scheduled for its next execution iteration.

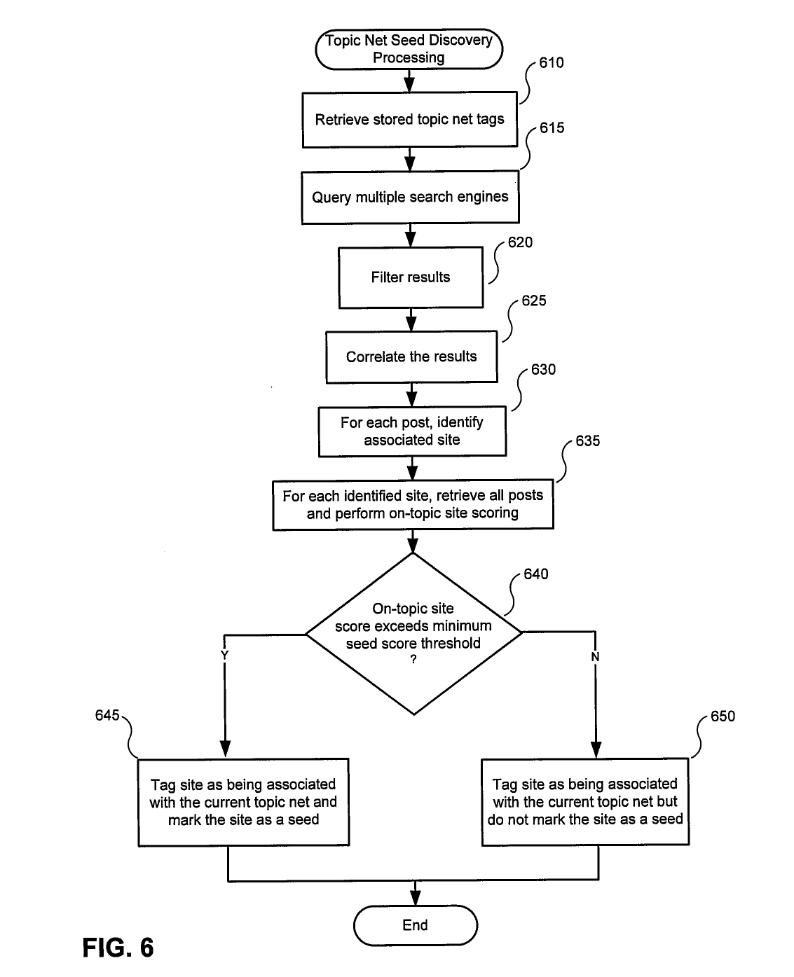

FIG. 6 is a flow diagram illustrating initial topic net seed discovery in accordance with an embodiment of the present invention. According to the present example, during this phase, the tags from the creation phase are used to run automated searches on several search engines. In one embodiment, the intersected results are analyzed in order to identify an initial list of seeds. Although ideal seeds will typically have a large following on the web and have high quality posts within the scope of the topic net, sufficient flexibility is desired to allow a new blog having a relatively smaller following to be selected as a seed if it has high quality and on-topic posts.

At block 610, the stored topic net tags, such as those stored during creation of the topic net in block 510, are retrieved.

At block 615, the retrieved topic net tags are used to query multiple search engines. Additionally or alternatively, Autonomy Retina™ can be used to suggest relevant documents, the BlogLines database may be queried for a subscription count for various blogs and/or results of other similar services may be considered as part of the initial seed discovery process.

At block 620, the results produced by block 615 are filtered. In one embodiment, spam filtering is used to differentiate between legitimate posts and spam posts, which are eliminated. Depending upon the implementation legitimate and spam posts may be differentiated based on their content and/or based on the site with which they are associated. For example, posts associated with spam blogs (splogs), artificially created weblog sites which the author may use for various purposes, such as promoting affiliated websites or to increase the search engine rankings of associated sites, may be eliminated without reference to the content of the post or the content of the blog home page.

In one embodiment, a splog detector includes a text classification engine that discriminates between URLs of legitimate blog home pages and spam blog home pages. As indicated above, according to one embodiment, the content of the blog home pages need not be considered, only the URL.

During a pre-deployment training phase, the splog detector may be presented with thousands of examples of blog home page URLs, previously categorized as either a spam blog or a legitimate blog. The result is a statistical model of the character sequences most indicative of spam-blog home page URLs. In production, the trained classifier may then be used to predict whether a particular blog entry is spam by presenting the blog's home page URL to classifier. If the URL is judged to be spam within a certain level of confidence, the blog entry is disregarded. According to one embodiment, the algorithms and data structures for the classifier may be based on the LingPipe software package, developed by Alias-i. The technique of using only the blog home page URL for classification is based on Salvetti, F., Nicolov, N., Spam Classification of Weblogs: A Language Model URLs Segmentation Approach, HLT-NAACL 2006: Human Language Technology Conference, New York City, N.Y., USA, 2006, which is hereby incorporated by reference in its entirety for all purposes. Minimum cross-entropy text classification is described by W. J. Teahan. 2000. Text classification using minimum cross-entropy. In RIAO 2000, which is hereby incorporated by reference in its entirety for all purposes.

At block 625, the filtered posts from the different search engines are correlated. In one embodiment, the intersection set among the search engine results is identified.

At block 630, the sites associated with the correlated search engine results are identified.

At block 635, for each site identified in block 630, all posts are retrieved (e.g., all posts are downloaded from the site's RSS feed) and on-topic percentage scoring is performed based on the corresponding retrieved posts. In one embodiment, on topic percentage scoring includes calculating the percentage of a site's on-topic content by comparing the topic net topics to the site's topics.

At decision block 640, a determination is made regarding whether the on-topic percentage score exceeds a minimum seed score threshold for the topic net. For example, the on-topic percentage score may be expected to have at least a minimum on-topic percentage to achieve and/or maintain seed status. If the on-topic score exceeds the minimum seed score threshold for the topic net, then processing continues with block 645; otherwise, processing branches to block 650.

At block 645, those of the sites having on-topic scores exceeding the minimum seed score threshold are tagged as being associated with the topic net and are also marked as seeds for the topic net.

At block 650, those of the sites having on-topic scores that do not exceed the minimum seed score threshold are tagged as being associated with the topic net, but are not marked as seeds for the topic net.

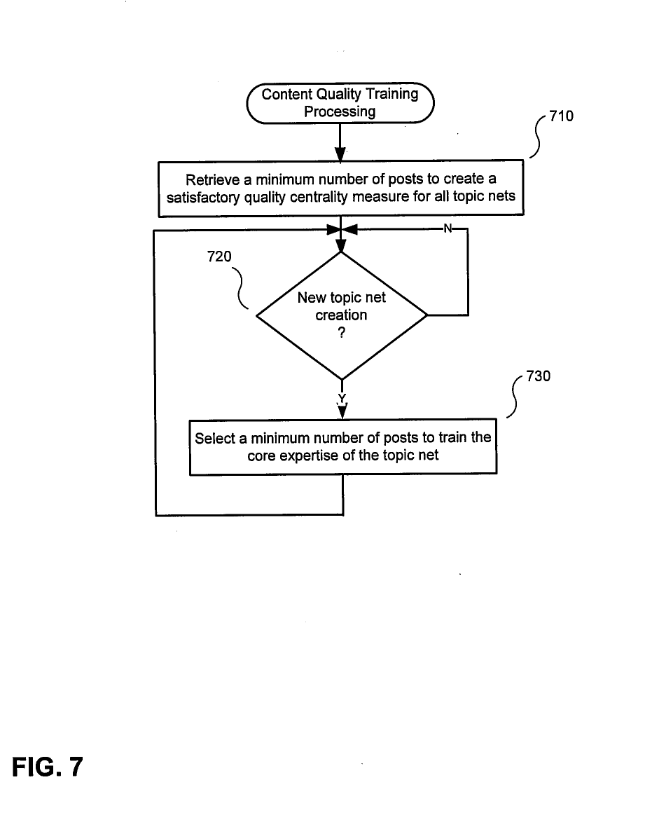

FIG. 7 is a flow diagram illustrating content quality training processing according to one embodiment of the present invention.

At block 710, for each topic net a minimum number of posts are retrieved from the tagged seed sites to create a satisfactory quality centrality measure for the topic net. In one embodiment, centrality measure may be selected from a predetermined set of algorithms, such as standard latent semantic analysis (LSA), which is described further below, probabilistic LSA, and the like. The minimum number of posts may vary depending upon the algorithm selected. The quality centrality measures may subsequently be used during site evaluation and scoring, such as block 635 of FIG. 6, to evaluate new posts in order to determine how close they are to what is considered to be a good post for the topic net at issue.

In one embodiment, content quality comparisons are performed using LSA. LSA is a method for exposing the latent contextual-meaning within a large body of text. It does this by looking at word usage (specifically, word co-occurrence) within a set of documents. Words, which appear in similar contexts, are assumed to have similar meanings. LSA starts by constructing a large matrix of term-document association data. Each cell in the matrix contains a weighted value, which is proportional to the number of times each term appears within each document in the set. The weights are structured such that rarer terms have greater weights. This allows more relevant terms (higher entropy) to carry more weight in the analysis. This matrix is then analyzed using singular value decomposition (SVD)—a process that constructs document and term spaces with each term and document represented by an n-dimensional vector within the space. Following this process, each document occupies a specified position within the semantic space, with similar documents appearing near each other. Using a simple vector distance measure, such as cosine or Euclidean distance, one can then perform document-to-document similarity measurements. Further information regarding LSA can be found in various SVD and LSI tutorials entitled “SVD and LSI Tutorial 1: Understanding SVD and LSI,” “SVD and LSI Tutorial 2: Computing Singular Values,” “SVD and LSI Tutorial 3: Computing the Full SVD of a Matrix,” “SVD and LSI Tutorial 4: Latent Semantic Indexing (LSI) How-to-Calculations” and “SVD and LSI Tutorial 5: LSI Keyword Research and Co-Occurrence Theory,” which are currently located at http;www.miislita.com/information-retreival-tutorial/svd-lsi-tutorial-1-understanding.html, http;www.miislita.com/information-retrieval-tutorial/svd-lsi-tutorial-2-computing-singular-values.html, http://www.miislita.com/information-retrieval-tutorial/svd-lsi-tutorial-3-full-svd.html, http://www.miislita.com/information-retrieval-tutorial/svd-lsi-tutorial-4-lsi-how-to-calculations.html, and http;//www.miislita.com/information-retrieval-tutorial/svd-lsi-tutorial-5-lsi-keyword-research-co-occurrence.html,

respectively, all of which are hereby incorporated by reference in their entirety for all purposes. After quality centrality measures have been determined for the existing topic nets, the content quality training process can monitor for new topic net creation to form a quality centrality measure for such new topic nets in decision block 720.

At decision block 720, the content quality training process determines whether a new topic net has been created. Upon detecting a new topic net or being notified of the new topic net, the process continues with block 730.

At block 730, when a new topic net is created, a minimum number of posts are retrieved from the tagged seed sites to create a satisfactory quality centrality measure for the new topic net. As indicated above, various centrality measures may be used and the current centrality measure for a particular topic net or for all topic nets may be a configurable parameter accessible by staff of the new media delivery service, such as operations team 230. The content quality training process may then continue to monitor for new topic net creation by looping back to decision block 720.

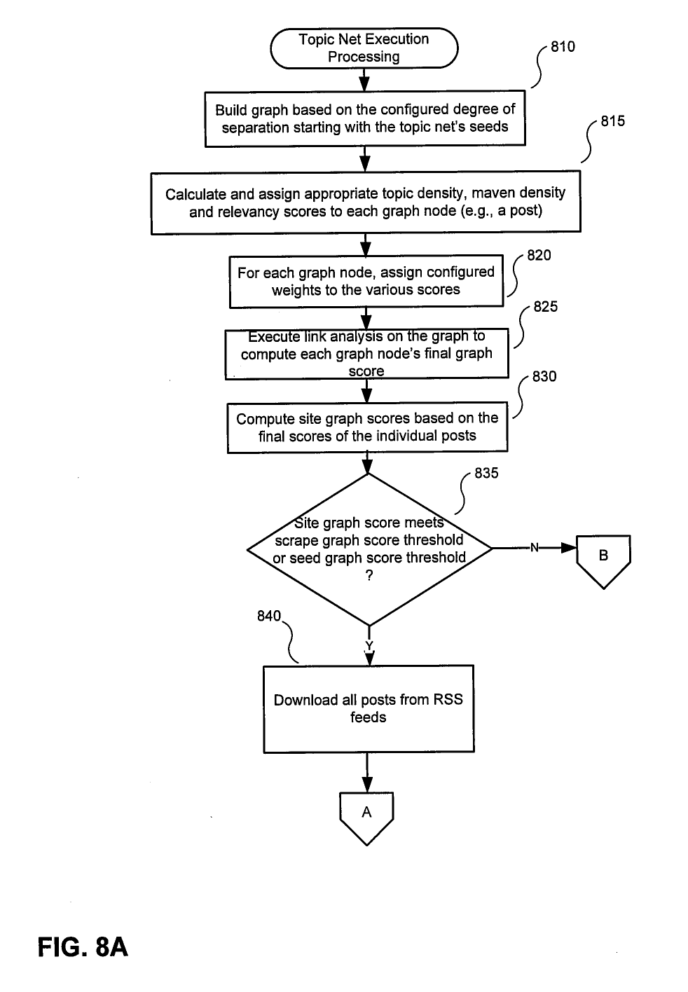

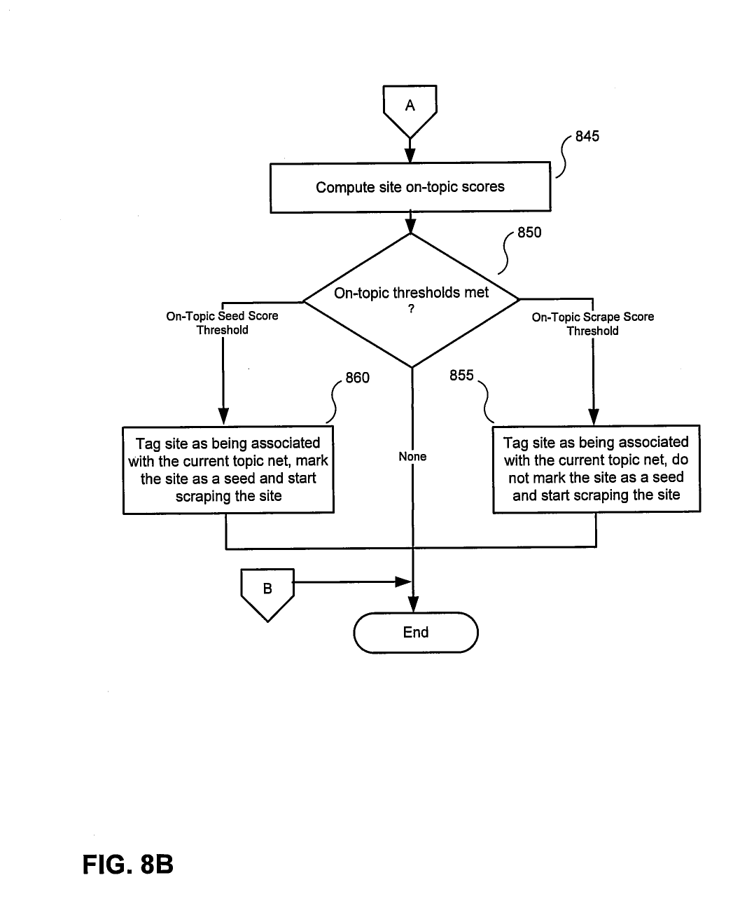

FIGS. 8A and 8B together represent a flow diagram illustrating topic net execution processing according to one embodiment of the present invention. In the present example, a graph is built by performing both forward and backward crawling from the seeds of the topic net. Nodes of the graph represent individual posts and the edges or links among the nodes represent inbound/outbound citations among the posts. Graph scores may then be assigned to the individual nodes. Then, a link analysis process is performed to compute final graph scores based on the association among the nodes. At this point final site graph scores may be determined for each blog based on the scores for the posts associated with a particular blog. Ultimately, blogs with both high graph scores and high on-topic scores will be candidates for regular monitoring and scraping. Depending on growth parameters, sites with very high on-topic and graph scores may be chosen, in an automated fashion, as seeds for subsequent execution of the topic net. In one embodiment, regular monitoring and scraping may be performed on a periodic basis. The frequency may vary based on the size, growth rate and other metrics associated with the topic net, but empirical evidence suggests executing the topic net on a weekly basis is sufficient for present purposes.

Topic net execution processing starts at block 810 in which a graph is built for the topic net at issue based on the configured degree of separation starting with the topic net's seeds. In one embodiment, the set of initial seeds are used in a 360 crawling mode. The 360 crawling mode may be defined by finding a list of posts linking to the seed (backward crawling) and also a list of posts to which the seed links to (forward crawling). Each subsequent level of crawling may consider these new posts identified by forward and backward crawling and perform a 360 crawl for each one until the desired number of iterations have been performed.

As indicated above, according to one embodiment, before a post becomes a candidate for crawling, a filter may be applied to determine the post is relevant to the topic net's expertise. If the post meets the configurable relevance threshold, then the post is recursed into the next iteration. If not, the post may be ignored. The result of the 360 crawl is a graph in which nodes represent individual posts and edges or links among the nodes are represent inbound/outbound citations among the posts.

In one embodiment, the configured degree of separation represents the number of iterations (levels) of backward and forward crawling to be performed in the 360 crawling mode. Depending upon the particular study, social network research and analysis suggest anywhere between 6 to 19 degrees of separation from any source blog to any destination blog. One study claims there is an average of 3 degrees of separation from any source blog to any A-list blog. At any rate, in one embodiment the number of iterations used in 360 crawling may vary between 3 to 15, inclusive.

At block 815, after the graph is built for the topic net, various scores, such as topic density, maven density and relevancy (content) scores, are calculated and assigned to each graph node (e.g., a post). In one embodiment, the relevancy score may be determined by comparing each graph node (e.g., a post) to the topic net's score or domain expertise defined by the post pool built during a training phase (see e.g., FIG. 7).

At block 820, for each node of the graph, configured weights are assigned to the various scores. In one embodiment, the same weights may initially be assigned to all nodes in the graph. These initial weights may then be augmented over time by the topic density and maven density scores, if any.

At block 825, a link analysis process is executed on the graph to compute each graph node's final score. According to one embodiment, once all weights are assigned, they are distributed among nodes of the graph through their corresponding inbound and outbound links. All weights may be distributed among all nodes in each iteration. Iterations may be repeated until the graph is balanced. The graph is considered balanced once each node's delta before and after weight assignment is below a configured value.

Various Web link analysis approaches may be used. Several Web search ranking algorithms use link-based centrality metrics, including Marchiori's Hyper Search (Massimo Marchiori, “The Quest for Correct Information on the Web: Hyper Search Engines.” The Sixth International WWW Conference (WWW 97). Santa Clara, USA, Apr. 7-11, 1997.), Google's PageRank (U.S. Pat. No. 6,285,999), Kleinberg's Hypertext Induced Topic Selection (HITS) algorithm (U.S. Pat. No. 6,112,202), and the TrustRank algorithm (Gyöngyi, Zoltán; Hector Garcia-Molina, Jan Pedersen (2004). “Combating Web Spam with TrustRank”. Proceedings of the International Conference on Very Large Data Bases 30:576.). All of the aforementioned link analysis approaches are hereby incorporated by reference in their entirety for all purposes.

In one embodiment, once all scores and weights have been assigned to all nodes, a link analysis on the graph assigns a single graph score to each node. The node with the highest graph score comprises a hub where the number of inbound/outbound links is maximized and the content is on topic and high quality.

At block 830, site graph scores are computed based on the final scores of the individual posts associated with the sites. In one embodiment, the site graph scores are computed by grouping all posts belonging to the same site and averaging all posts' scores. Application of the distribution mechanism of block 825 along with the post aggregation of this step, results in certain sites becoming hubs with high credibility scores.

At decision block 835, the final site graph scores are compared to a scrape graph score threshold and/or a seed graph score threshold to determine whether all posts from the site are to be downloaded. If the final site graph score exceeds either or both of the scrape graph score threshold and the seed graph score threshold, then processing continues with block 840. Otherwise, topic net execution processing is complete.

At block 840, all posts are downloaded from the RSS feeds for sites meeting the graph score thresholds.

At block 845, on-topic scores are computed for the sites meeting the graph score thresholds. The on-topic score generally represents a site score measuring the ratio of on-topic posts to total posts for a particular site. In one embodiment, all posts from a given site are evaluated to determine whether they are on of off-topic within the current topic net. Then, the on-topic score can be computed by dividing the number of on-topic posts by the total number of posts analyzed for the site.

At decision block 850, a determination is made regarding whether a site's on-topic score meets one or more on-topic thresholds. According to the present example, if the site's on-topic score meets or exceeds the on-topic seed score threshold, then processing proceeds to block 860. If the site's on-topic score meets or exceeds the on-topic scrape score threshold, then processing continues with block 855. Otherwise, topic net execution processing is complete.

At block 860, the site is tagged as being associated with the current topic net and scraped on a periodic basis for content delivery to subscribers. As a result of this site's high on-topic score and to facilitate subsequent automated execution of this topic net, the site may also be marked as a seed for the next scheduled topic net execution.

At block 855, the site is tagged as being associated with the current topic net and scraped on a periodic basis for content delivery to subscribers; however, because the site's on-topic score is not sufficiently high, the site is not marked as a seed for the next scheduled topic net execution.

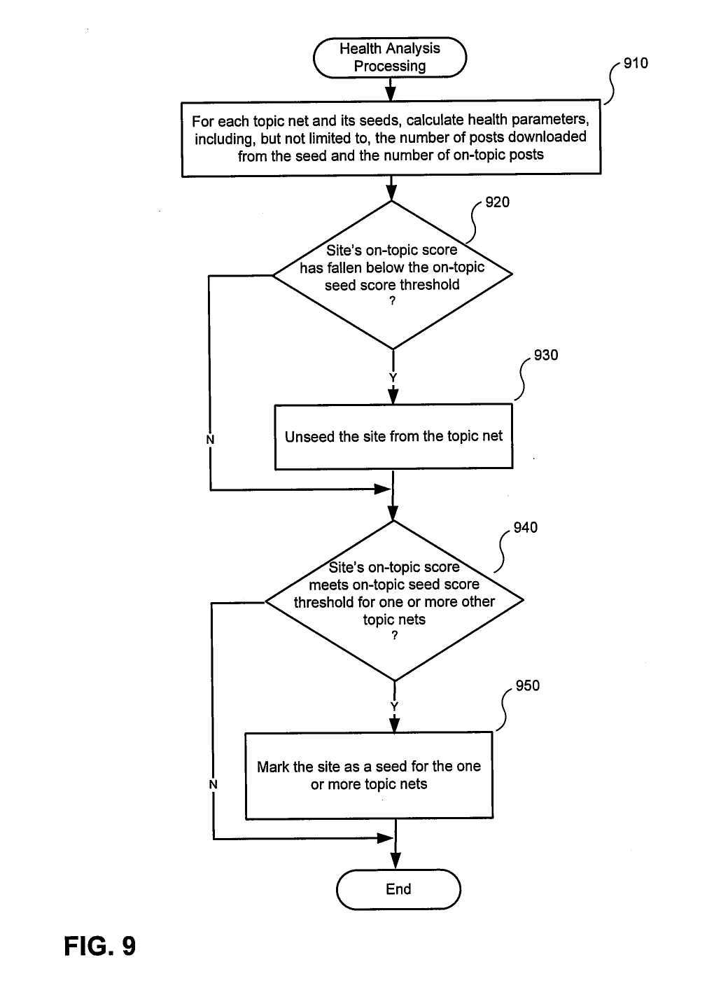

FIG. 9 is a flow diagram illustrating health analysis processing according to one embodiment of the present invention. According to one embodiment, the health analysis processing of block 530 of FIG. 5 is performed in accordance with the description of the flow diagram of FIG. 9.

In one embodiment, various health parameters are regularly tracked and measured to monitor the health of existing topic nets. Sample health parameters include minimum post count, maximum post count and average post score. One or more of the health parameters may help identify a topic net that is in declining health. In one embodiment, a potential remedy for a topic net in declining health is to perform incremental seeding by adding new or addition seeds to the topic net. For example, a topic net that does not produce a sufficient number of new posts within a predefined period or maintain a certain active blog count may be manually or programmatically determined to need additional seeding to improve the health of the topic net. A topic net that exceeds a certain number of posts may be a candidate for splitting into multiple topic nets. A topic net that does not meet a minimum threshold in terms of its average post content (relevancy) score may be deemed unhealthy as a result of inclusion of low quality posts.

In the context of FIG. 5, following each topic net execution iteration all sites associated with a topic net, including seeds and those sites that are merely scraped and monitored, and their scraped posts are analyzed according to health parameters defined during creation of the topic net. If one or more values fall below certain thresholds, certain actions, such as automatic seeding will be taken in order to adjust the health of the topic net. In addition, all seeds of a topic net may be analyzed to validate their continuing seed status. According to one embodiment, a topic net seed could be either unseeded if not enough on-topic posts have been published, or the seed could be moved to another topic net if published posts demonstrate a shift of expertise to another topic net.

According to the current example, topic net health analysis processing begins at block 910. At block 910, appropriate information is gathered and health parameters are calculated for each topic net and all seeds of the topic net. According to one embodiment, the health parameters include metrics, such as the number of posts downloaded from the seed during the last topic net execution iteration, the number of on-topic posts and the on-topic score.

At decision block 920, the site's on-topic score is compared to the on-topic seed score threshold to determine whether the site has fallen below the threshold to remain a seed. If so, the processing continues with block 930; otherwise, processing branches to decision block 940.

At block 930, it has been determined that the site is no longer worthy of maintaining its seed status. Consequently, the site is unseeded by marking it to indicate the site is no longer a seed for the topic net at issue.

At decision block 940, the site's on-topic score is compared to the on-topic seed score thresholds for one or more other current topic nets to determine whether the site may be an appropriate seed for the one or more other current topic nets. If the site's on-topic score meets the threshold for another current topic net, then processing continues with block 950; otherwise health analysis processing is complete.

At block 930, it has been determined that the site meets the minimum requirements to be considered a seed for one or more different topic nets. For each of the topic nets that the site qualifies as a seed, the site is marked to identify it as a seed for subsequent execution of such topic nets.

FIG. 10 conceptually illustrates potential hubs or seeds in the context of a sample mapping of a sites under consideration to be part of a topic net according to one embodiment of the present invention. In the present example, various sites are marked with a number from 1 to 6. Those marked with a ‘1’ may represent the hubs identified by one iteration of the 360 crawl. Those marked with a ‘2’ may represent hubs identified after an additional iteration of the 360 crawl and so on. Thus, it may be seen that the iterative 360 crawl provides good coverage in the context of the sample mapping and provides subscribers of the new media delivery service with the opportunity to read posts by not only A-list blogs (e.g., those in the most dense portion of the sample mapping), but other blogs with high quality posts and on-topic content that may not have otherwise been discovered.

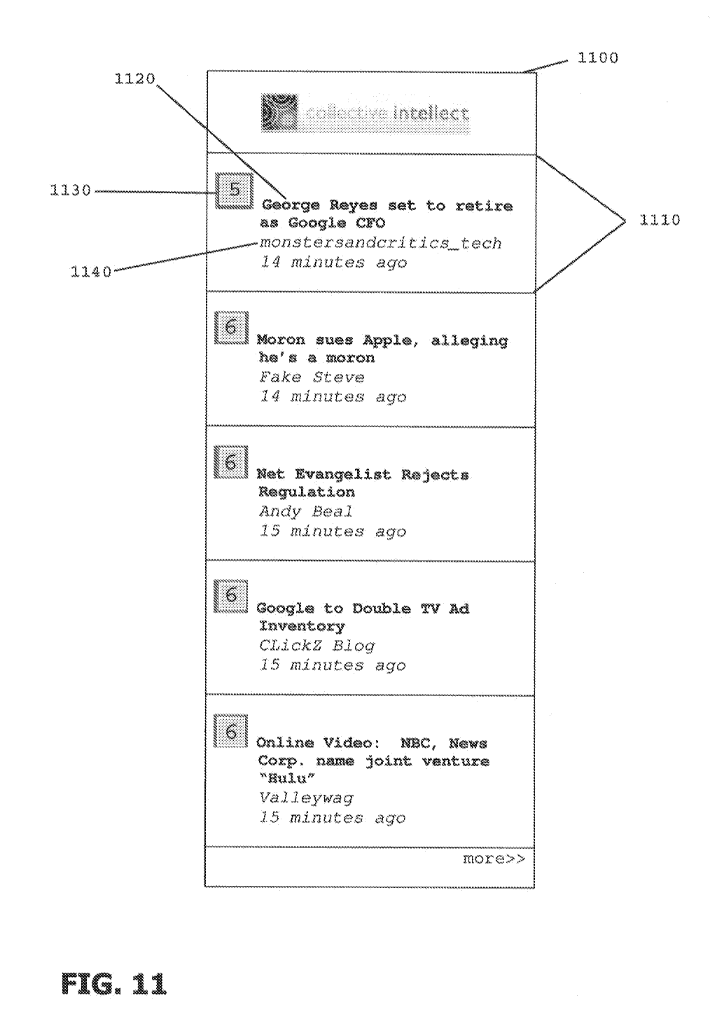

FIG. 11 illustrates a user interface widget 1100 through which end users of subscribers can access on-topic content in accordance with an embodiment of the present invention. According to one embodiment, subscribers of the new media delivery service are alerted to relevant content and review such relevant content via the user interface widget 1100. In the present example, the user interface widget 1100 includes multiple blog post summaries a sample of which is identified by reference numeral 1110. Each blog post summary includes a content rating 1130, a title 1120 and information indicative of the source and timeliness of the post 1140. Based on the blog post summary, end users can decide whether to obtain further information regarding the post, such as the full content of the post or related posts.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method of identifying sources of media content having a high likelihood of producing on-topic content, the method comprising:
responsive to receiving a definition of a topic area of interest of a plurality of topic areas of interest, identifying a set of candidate seed sites from which a current set of seeds are selected for deep crawling to locate on-topic content relevant to the topic area of interest by
correlating relevancy scores or key-word search results from a plurality of search engines; and
selecting the current set of seeds from the candidate seed sites based at least in part on on-topic scores associated with the candidate seed sites;
periodically executing a topic net corresponding to the topic area of interest to locate sources of media content relevant to the topic area of interest by
building a graph in which nodes of the graph represent pages and edges of the graph represent links among pages by performing an iterative crawl until a predetermined degree of separation is achieved to find a list of pages linking to any seed of the current set of seeds and a list of pages to which any seed of the current set of seeds links;
assigning initial graph scores to each node of the graph;
computing final graph scores for each node based on the initial graph scores by performing link analysis on the graph;
computing a site graph score for each site represented in the graph by its set of pages by aggregating and averaging the node graph scores associated with the site; and
identifying a set of sites with the highest site graph scores and configuring them to be scraped; and
scraping and downloading pages associated with the sites configured to be scraped.

2. The method of claim 1, wherein the set of sites and the current set of seeds comprise weblogs (blogs) and the pages comprise blog posts.

3. The method of claim 2, further comprising measuring the health of the plurality of topic areas of interest by performing health analysis.

4. The method of claim 3, wherein said performing health analysis comprises:
producing metrics relating to various health parameters for each site of the set of sites and each seed of the current set of seeds, including a number of new posts created and an average post relevancy score, by evaluating posts associated with the set of sites and the current set of seeds; and
adding or subtracting seeds from the current set of seeds for use in a next topic net execution iteration based on the metrics.

5. The method of claim 2, further comprising creating a quality centrality measure for each of the plurality of topic areas of interest.

6. The method of claim 5, wherein the quality centrality measure is based upon latent semantic analysis.

7. The method of claim 2, wherein the initial graph scores are based upon one or more of a topic density score, a maven density score and a relevancy score.

8. The method of claim 2, further comprising prior to selecting the current set of seeds from the candidate seed sites, performing filtering to remove spam blogs from the candidate seed sites.

9. The method of claim 8, wherein the filtering comprises use of a spam blog (splog) detector comprising a text classification engine that discriminates between uniform resource locators (URLs) of legitimate blog home pages and splog home pages.

10. A computer program product, for use with a computer system, for directing the computer system to identify sources of media content having a high likelihood of producing on-topic content, the computer program product comprising:
a computer-readable medium;
means, provided on the computer-readable medium, for directing the computer system to identifying a set of candidate seed sites from which a current set of seeds are selected for deep crawling to locate on-topic content relevant to a topic area of interest of a plurality of topic areas of interest by
correlating relevancy scores or key-word search results from a plurality of search engines; and
selecting the current set of seeds from the candidate seed sites based at least in part on on-topic scores associated with the candidate seed sites;
means, provided on the computer-readable medium, for directing the computer system to periodically executing a topic net corresponding to the topic area of interest to locate sources of media content relevant to the topic area of interest by
building a graph in which nodes of the graph represent pages and edges of the graph represent links among pages by performing an iterative crawl until a predetermined degree of separation is achieved to find a list of pages linking to any seed of the current set of seeds and a list of pages to which any seed of the current set of seeds links;
assigning initial graph scores to each node of the graph;
computing final graph scores for each node based on the initial graph scores by performing link analysis on the graph;
computing a site graph score for each site represented in the graph by its set of pages by aggregating and averaging the node graph scores associated with the site; and
identifying a set of sites with the highest site graph scores and configuring them to be scraped; and
scraping and downloading pages associated with the sites configured to be scraped.

11. The computer program product of claim 10, wherein the set of sites and the current set of seeds comprise weblogs (blogs) and the pages comprise blog posts.

12. The computer program product of claim 11, further comprising means, provided on the computer-readable medium, for directing the computer system to measure the health of the plurality of topic areas of interest by performing health analysis.

13. The computer program product of claim 12, wherein said performing health analysis comprises:
producing metrics relating to various health parameters for each site of the set of sites and each seed of the current set of seeds, including a number of new posts created and an average post relevancy score, by evaluating posts associated with the set of sites and the current set of seeds; and
adding or subtracting seeds from the current set of seeds for use in a next topic net execution iteration based on the metrics.

14. The computer program product of claim 11, further comprising means, provided on the computer-readable medium, for directing the computer system to create a quality centrality measure for each of the plurality of topic areas of interest.

15. The computer program product of claim 14, wherein the quality centrality measure is based upon latent semantic analysis.

16. The computer program product of claim 11, wherein the initial graph scores are based upon one or more of a topic density score, a maven density score and a relevancy score.

17. The computer program product of claim 11, further comprising means, provided on the computer-readable medium, for directing the computer system to prior to selection of the current set of seeds from the candidate seed sites, perform filtering to remove spam blogs from the candidate seed sites.

18. The computer program product of claim 17, wherein the filtering comprises use of a spam blog (splog) detector comprising a text classification engine that discriminates between uniform resource locators (URLs) of legitimate blog home pages and splog home pages.
